(19) United States
(12) Patent Application Publication
(10) Pub. No.: US 2006/0209350 A1
(43) Pub. Date: Sep. 21, 2006

(54) Image processing apparatus

(75) Inventor: Sunao Tabata, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/081,938

(22) Filed: Mar. 17, 2005

(51) Int. Cl. G06K 9/00

(52) U.S. Cl. 358/3.28; 382/100

(57) ABSTRACT

An image processing apparatus includes a scanner that relatively moves an image on an original in a sub-scan direction, and reads the image, a main-scan magnification varying section that varies a magnification of image data, which is read by the scanner, in a main-scan direction, a sub-scan magnification varying section that varies a magnification of image data, which is read by the scanner, in the sub-scan direction, a watermark detection section that detects watermark information from the image data that is read by the scanner, and a control circuit that issues an instruction to the scanner, the main-scan magnification varying section and the sub-scan magnification varying section in accordance with a desired magnification ratio.

### BACKGROUND OF THE INVENTION

1. Field of the Invention

The present invention relates to an image processing apparatus that processes an image using a watermark technique.

2. Description of the Related Art

In recent years, encryption techniques and electronic watermark techniques have been used in various fields because of the importance of data management. This similarly applies to a system having a completely digital architecture and to a system including both a digital architecture and an analog architecture, such as a digital copying machine.

Documents 1 to 4, for instance, describe watermark techniques:

Document 1: Jpn. Pat. Appln. KOKAI Publication No. 2003-134327,

Document 2: Jpn. Pat. Appln. KOKAI Publication No. 2004-46374,

Document 3: Jpn. Pat. Appln. KOKAI Publication No. H3-233578, and

Document 4: Jpn. Pat. Appln. KOKAI Publication No. 2001-77980.

Document 1 discloses a technique wherein watermark detection is executed for data that is read by a scanner. Depending on the presence/absence of a watermark, information about a watermark detection result is given, or a watermark is removed in combination with user authentication, etc.

Document 2 discloses a technique wherein an index, which is buried as a watermark, is extracted from a scanned document image. A corresponding document image is read out from a storage section and printed out in place of the scan image. If the corresponding document image is absent, the scan image is printed out.

Document 3 discloses a technique for providing a function of printing images of a plurality of pages on a single sheet in a copier, which is generally called “Nin1”.

Document 4 discloses a technique wherein a carriage control, which is scanning means in a scanner, is associated with only a specific magnification, and other sub-scan magnifications are generated by signal processing.

As regards watermark techniques, as disclosed in Documents 1 and 2, a method of overlay on print and a function using the related information are proposed. In these examples, a difficult-to-perceive watermark, which is called an invisible watermark, is used. However, watermark pattern information, which is intentionally made perceptible and is called a visible watermark, may be laid on an original image and printed out.

On the other hand, the functions of a copying machine and a printer also include the function of printing a plurality of input images on a single paper sheet, which is called “Nin1”, as disclosed in Document 3. In the actual copier, an output result of the same size as an input original is not merely obtained, but a function of enlargement/reduction printing is provided. The Nin1 function is one of new functions using the enlargement/reduction printing. However, an increase in cost would arise if data of all magnifications are routinely generated by an image input section. Thus, the technique of Document 4 is proposed.

As disclosed in Documents 1 and 2, the functions using the watermark printing and the watermark technique have been proposed. However, in the case where various input/output patterns, as in Documents 3 and 4, are combined with watermark techniques, it is not clear how to apply the watermark and to read the watermark.

As discussed above, even if the individual functions are independently provided, there is difficulty in actually using the respective functions in combination.

### BRIEF SUMMARY OF THE INVENTION

The object of an aspect of the present invention is to provide an image processing apparatus that effectively uses a watermark even in an environment in which various inputs/outputs are executed.

According to an aspect of the present invention, there is provided an image processing apparatus comprising: image input means for relatively moving an image on an original in a sub-scan direction, and reading the image; first magnification varying means for varying a magnification of image data, which is read by the image input means, in a main-scan direction; second magnification varying means for varying a magnification of image data, which is read by the image input means, in the sub-scan direction; magnification varying instruction means for issuing an instruction to the image input means, the first magnification varying means and the second magnification varying means in accordance with a desired magnification; and watermark detection means for detecting watermark information from the image data that is read by the image input means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a digital multi-function peripheral according to a first embodiment;

FIG. 2 shows an external structure of a scanner in the first embodiment;

FIG. 3 illustrates an image of an input signal;

FIG. 4 schematically shows the structure of a watermark detection section in the first embodiment;

FIG. 5 shows examples of an analysis TBL 1 and an analysis TBL 2 in the watermark analysis section;

FIG. 6 shows an example of frequency detection and interpretation;

FIG. 7 is a block diagram that schematically shows the structure of a digital multi-function peripheral according to a modification of the first embodiment;

FIG. 8 shows an example of the operation of the modification of the first embodiment;

FIG. 9 is a block diagram that schematically shows the structure of a digital multi-function peripheral according to a second embodiment;

FIG. 10A shows an example of a display operation on a control panel;

FIG. 10B shows an example of the display operation on the control panel;

FIG. 11A shows an example of the display operation on the control panel;

FIG. 11B shows an example of the display operation on the control panel;

FIG. 12 is a block diagram that schematically shows the structure of a digital multi-function peripheral according to a third embodiment;

FIG. 13 shows an example of the display operation on the control panel; and

FIG. 14 shows an example of an operation of “AI2in1”.

### DETAILED DESCRIPTION OF THE INVENTION

Embodiments of the present invention will now be described with reference to the accompanying drawings.

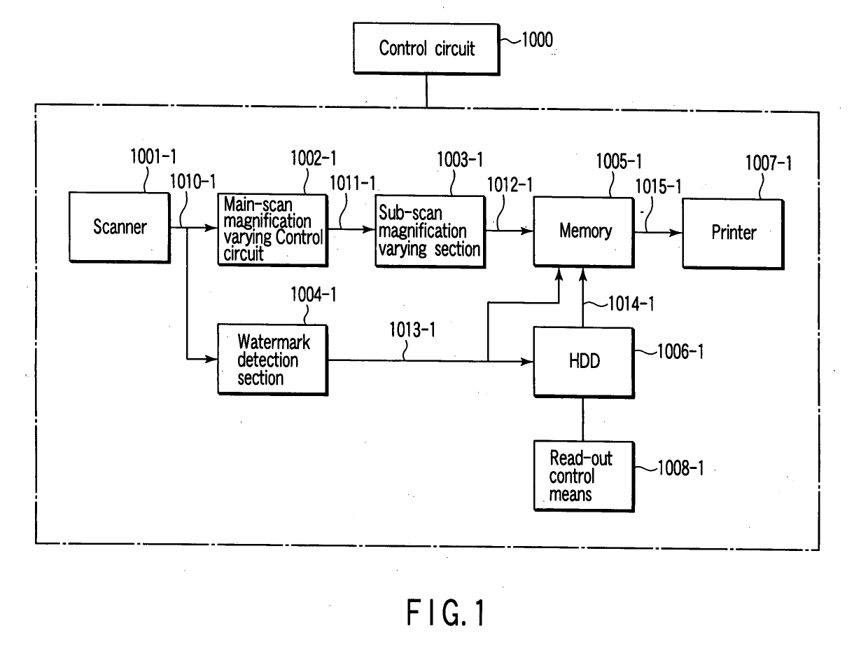

FIG. 1 schematically shows the structure of a digital multi-function peripheral (MFP) according to a first embodiment, which relates to an image processing apparatus of the present invention.

Specifically, the digital MFP of the first embodiment comprises a control circuit 1000, a scanner 1001-1, a main-scan magnification varying section 1002-1, a sub-scan magnification varying section 1003-1, a watermark detection section 1004-1, a memory 1005-1, large-capacity storage media 1006-1, a printer 1007-1, and read-out control means 1008-1.

The control circuit 1000 executes an overall control of the digital MFP.

The scanner 1001-1 inputs an image on an original.

The main-scan magnification varying section 1002-1 varies a magnification of a scanner signal 1010-1 in a main-scan direction in accordance with a magnification-varying instruction.

The sub-scan magnification varying section 1003-1 varies a magnification of a main-scan magnification-varied signal 1011-1 in a sub-scan direction in accordance with a magnification-varying instruction.

The watermark detection section 1004-1 detects a watermark from the scanner signal 1010-1.

The memory 1005-1 stores magnification-varied image data 1012-1 or image data 1014-1 that is read out by the read-out control means 1008-1.

The large-capacity storage media 1006-1 is a hard disk drive (HDD) that stores data such as a watermark detection result 1013-1.

The printer 1007-1 prints out image data 1015-1 that is read out from the memory 1005-1.

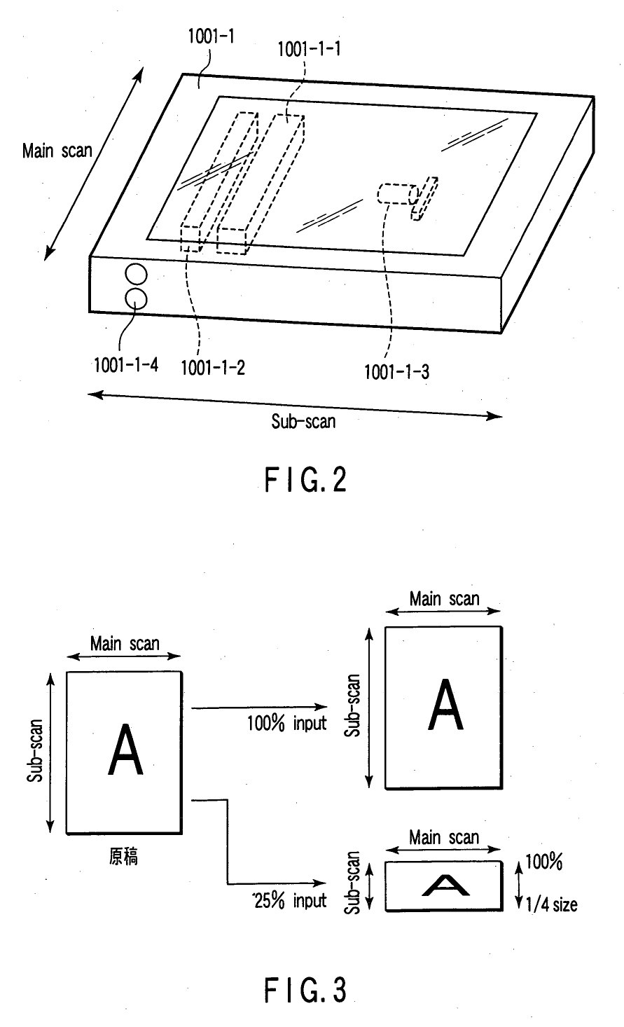

FIG. 2 shows an external structure of the scanner 1001-1. As shown in the Figure, the scanner 1001-1 is a conventional one, which is generally called a line-scan type scanner. The scanner 1001-1 comprises a lamp & mirror unit 1001-1-1 that illuminates an original; a second mirror unit 1001-1-2 that guides reflective light from the illuminated original into a lens unit 1001-1-3; and a motor 1001-1-4 that scans the lamp & mirror unit 1001-1-1 and second mirror unit 2001-1-2 over the original table in a sub-scan direction.

For example, the scanner 1001-1 realizes sub-scan magnification variation at 100% and 50% by a carriage operation. In a range between 99% and 51%, the scanner 1001-1 generates magnification-varied images by the sub-scan magnification varying section 1003-1 from 100%. In a range between 49% and 25%, the scanner 1001-1 similarly generates magnification-varied images by the sub-scan magnification varying section 1003-1 from 50%.

In general, because of the structure of the mechanism of the above-described type of scanner, an image signal 1010-1 that is obtained by a magnification-varying process has shapes as shown in FIG. 3. In the main scan direction, the magnification of the image is 100% regardless of a magnification-varying instruction. On the other hand, in the sub-scan direction, scanning is executed by varying the speed for mechanically scanning a sensor (not shown). Thus, image data that is reduced from the beginning is digitally generated.

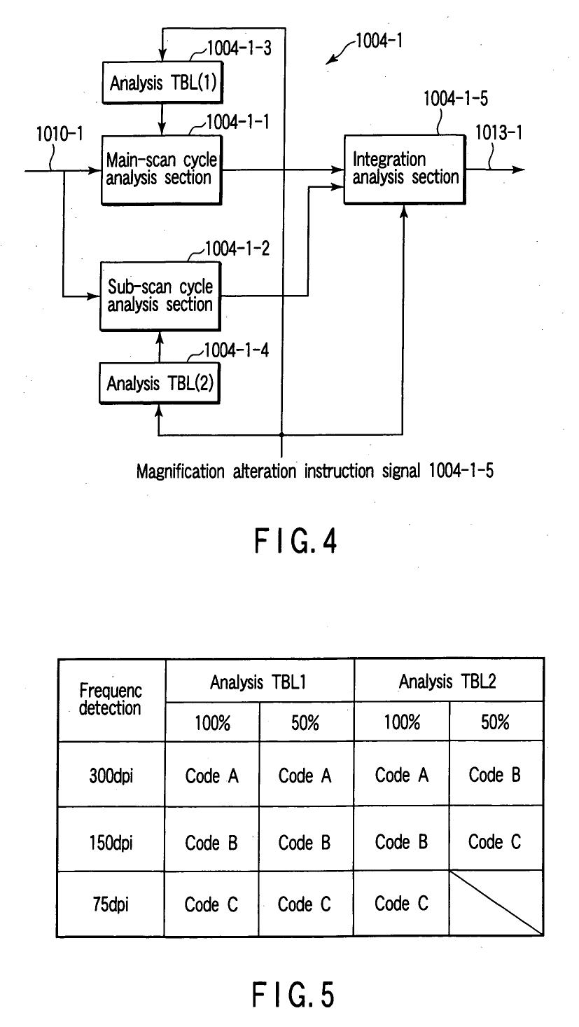

FIG. 4 schematically shows the structure of the watermark detection section 1004-1. The watermark detection section 1004-1 comprises a main-scan cycle analysis section 1004-1-1, a sub-scan cycle analysis section 1004-1-2, an analysis TBL(1) 1004-1-3 (hereinafter referred to as “analysis TBL1), an analysis TBL(2) 1004-1-4 (“analysis TBL2”), and an integration analysis section 1004-1-5.

The main-scan cycle analysis section 1004-1-1 analyzes the input image signal 1010-1 to the watermark detection section using the value of the analysis TBL1, and produces a main-scan cycle analysis result.

Similarly, the sub-scan cycle analysis section 1004-1-2 produces a sub-scan cycle analysis result using the value of the analysis TBL2.

The integration analysis section 1004-1-5 integrally analyzes both analysis results, and outputs an analysis result 1013-1.

A magnification variation instruction signal 1004-1-5 is input from the control circuit 1000 to the analysis TBL1, analysis TBL2 and integration analysis section 1004-1-5.

FIG. 5 shows examples of the analysis TBL 1 and analysis TBL 2 in the watermark analysis section 1004-1. The analysis TBL1 and analysis TBL2 have TBL values for the magnification variation instruction signal 1004-1-5 (e.g. magnification variations at 100% and 50%). The main-scan cycle analysis section 1004-1-1 operates in main scan, and refers to the analysis TBL1 for code information corresponding to a predetermined cycle. The sub-scan cycle analysis section 1004-1-2 operates in sub-scan, and refers to the analysis TBL2 for code information corresponding to a predetermined cycle.

In this embodiment, main scan is executed at only 100% in the apparatus configuration. Thus, the analysis TBL1 outputs a fixed value, regardless of the magnification variation instruction signal 1004-1-5. In the analysis TBL2, the code to be interpreted is varied in accordance with the magnification variation instruction signal 1004-1-5. The reason is that the normal relationship between the code and resolution is shifted by the magnification variation input. It is understood that in the sub-scan direction, information that is scanned at a cycle of 300 dpi at 100% is not input.

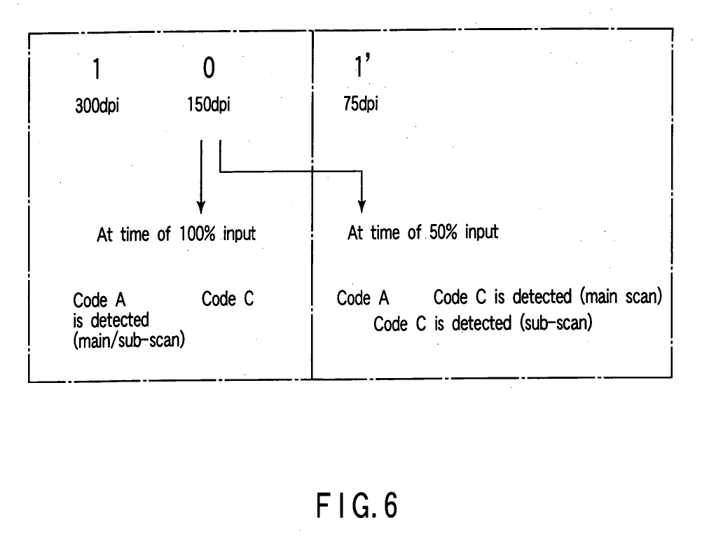

FIG. 6 illustrates an example of frequency detection and interpretation. In FIG. 6, it is understood that even if the frequency detection result is the same, a difference occurs in detectable information level, depending on whether the input is 100% or 50%. For example, if a code A is a document number, it is detected whether a document having the corresponding number is stored in the HDD 1006-1. If there is the document having the corresponding number, document 1014-1 is read out from the HDD 1006-1. If necessary, the document is subjected to magnification alteration and stored in the memory 1005-1. If there is no document having the corresponding number, the magnification-varied scan image data 1012-1 is stored in the memory 1005-1.

Thereby, the stored document data is used and printed in place of the input image data. Thus, high-quality data can be used. If the integration analysis section 1004-1-5 preferentially adopts a main-scan analysis result with respect to main-scan and sub-scan analysis results, it is possible to match with an input of 100% and a magnification-varied input. Hence, the range of available functions using watermarks can be made wider.

A plurality of images may be gathered, and detected and stored. With this configuration, detection means may detect a page number, and watermark information may be used for a properly input original document. Thereby, correctly rearranged output image data can be obtained. As a matter of course, the user may intentionally change the order of page numbers. In this case, selection is made executable by a mode key. Thereby, operability can be enhanced.

In this embodiment, the TBL for interpreting detection results is altered. Alternatively, it is possible to alter the detection side, from the beginning, in accordance with the magnification variation instruction signal 1004-1-5.

As the example of the frequency detection, the main/sub-scan is individually interpreted in a simple fashion. The same technical idea is applicable to the case in which a pattern is inserted in an oblique direction. Since the effect of sub-scan occurs, relative to the case of main-scan alone, detection may be executed in consideration of overlap. Further, in the case of the scanner of this embodiment in which the mechanical sub-scan magnification is limited, the number of frequencies to be considered is small and the degree of freedom of design is increased. However, the scanner structure is not limited to this embodiment, and the function of the invention is applicable to the conventional type in which each magnification is mechanically generated.

Next, a modification of the first embodiment is described.

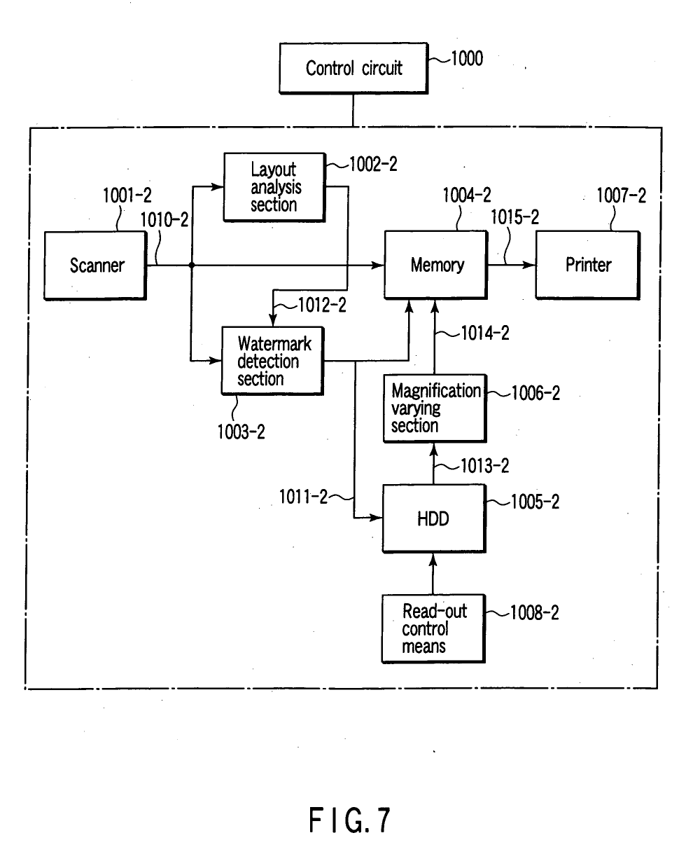

FIG. 7 schematically shows the structure of a digital multi-function peripheral (MFP) according to the modification of the first embodiment. Specifically, the digital MFP according to the modification of the first embodiment comprises a control circuit 1000, a scanner 1001-2, a layout analysis section 1002-2, a watermark detection section 1003-2, a memory 1004-2, large-capacity storage media (HDD) 1005-2, a magnification varying section 1006-2, a printer 1007-2, and read-out control means 1008-2.

An image signal 1010-2 from the scanner 1001-2 is input to the conventional layout analysis section 1002-2, watermark detection section 1003-2 and memory 1004-2. The watermark detection section 1003-2 detects a watermark using a layout analysis result 1012-2, and outputs a watermark detection signal 1011-2. In accordance with the watermark detection signal 1011-2, the read-out control means 1008-2 reads out image data 1013-2 from the HDD 1005-2 and stores a signal 1014-2, which is subjected to magnification alteration in the magnification varying section 1006-2, in the memory 1004-2. Either the image signal 1010-2 from the scanner 1001-2 or the signal 1014-2 from the HDD 1005-2 is output from the memory 1004-2 to the printer 1007-2.

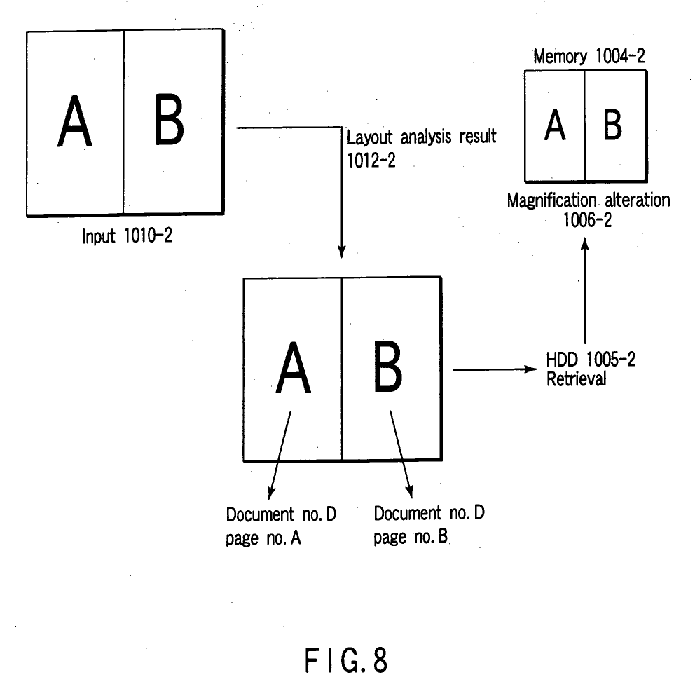

FIG. 8 illustrates an example of this operation. Specifically, when the input is interpreted as a 2in1 image on the basis of the layout analysis result, the watermark detection section 1003-2 receives the layout information 1012-2, and detects a watermark in each document area and obtains document numbers and page numbers. Subsequently, the associated documents and pages are retrieved in the HDD 1005-2. The associated documents and pages are read out and subjected to magnification alteration in the magnification varying section 1006-2. Thus, a 2in1 image can be reproduced in the memory 1004-2.

Since an image is created directly from the stored data, and not from the scanned original, a high-quality image can be obtained.

In addition, a high image quality is realized in the process of separately outputting 1-page units of the 2in1 image.

In this embodiment, the layout analysis section is used. If layout information is buried in an Nin1 image from the beginning, the same function can be realized without the layout function.

Conversely, layout information that is detected on the basis of the watermark may be input to the layout analysis section. In this case, since the Nin1 image that is a large layout has become clear, a detailed analysis can be executed within the Nin1 image. With this scheme, the layout analysis precision can be improved.

Next, a second embodiment is described.

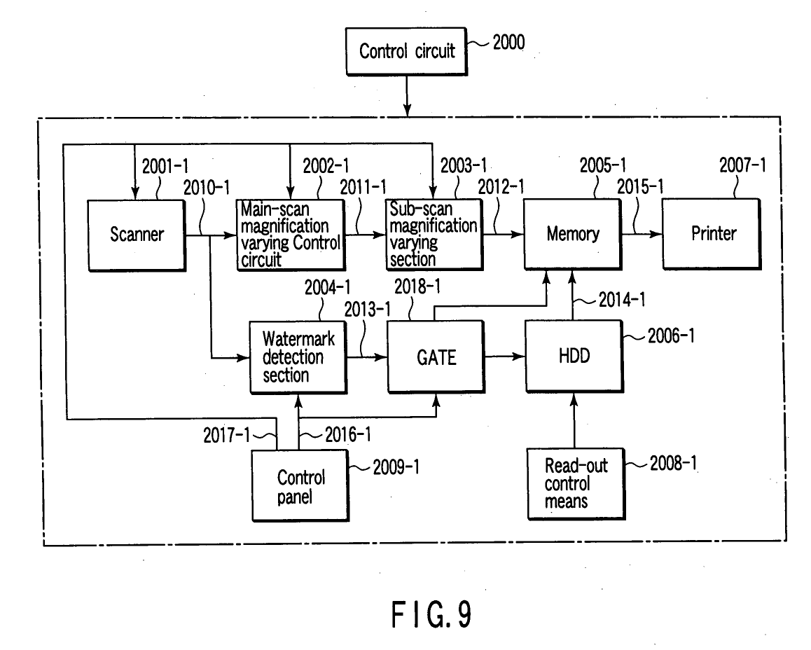

FIG. 9 schematically shows the structure of a digital multi-function peripheral (MFP) according to the second embodiment. Specifically, the digital MFP of the second embodiment comprises a control circuit 2000, a scanner 2001-1, a main-scan magnification varying section 2002-1, a sub-scan magnification varying section 2003-1, a watermark detection section 2004-1, a memory 2005-1, large-capacity storage media (HDD) 2006-1, a printer 2007-1, read-out control means 2008-1, a control panel 2009-1, and a gate 2018-1.

The second embodiment is the same as the first embodiment, except for explicit descriptions of the control panel 2009-1, control signal 2016-1 and control signal 2017-1. Thus, a description of the other parts is omitted here.

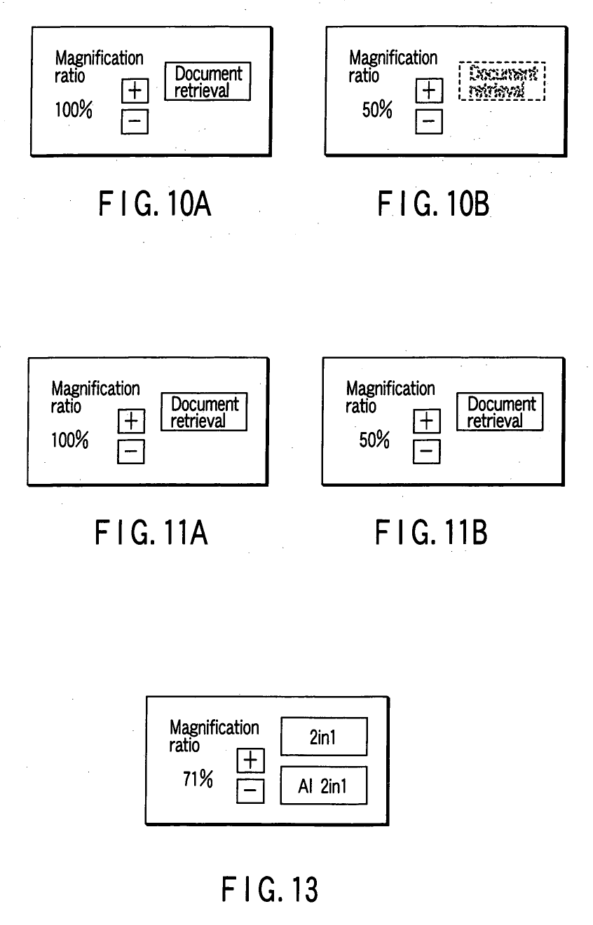

FIGS. 10A and 10B show examples of the display operation on the control panel 2009-1. As is shown in FIG. 10A, document retrieval is available in a 100% copy mode. On the other hand, document retrieval is not available in a 50% copy mode, as shown in FIG. 10B. The reason is that the detection level varies due to the magnification variation, as has been described with reference to FIG. 5. In the second embodiment, the document retrieval function cannot be used unless the detection precision in main scan and the detection precision in sub-scan coincide. At a time of magnification variation, the document retrieval function is made non-usable.

In a mode shown in FIG. 10B, the control signal 2017-1 is a signal for instructing a magnification variation of 50%, and the control signal 2016-1 is an instruction signal relating to the retrieval function, that is, the control signal 2016-1 closes the gate 2018 to the HDD 2006-1.

However, all watermark functions are not suspended. For example, in the case where the code C in FIG. 5 is information indicative of presence/absence of copy prohibition, since detection is executable even at the time of magnification variation, an instruction is issued to clear the memory 2005-1 in the case of copy prohibition. In other words, the level of the function using the watermark can be switched in accordance with the instruction relating to the magnification variation. Thereby, the range of uses of the watermark can be increased.

A basic information check, such as a copy prohibition operation, is executed regardless of magnification variation. Thus, watermark information can safely be used.

In this embodiment, simple magnification variation is exemplified. Even in the case of Nin1 copy, the magnification variation is similarly used in this function. Thus, the limitation to use can be effected.

Next, a modification of the second embodiment is described.

FIGS. 11A and 11B show examples of the display operation on the control panel 2009-1 in the modification of the second embodiment. In the modification of the second embodiment, as is shown in FIGS. 11A and 11B, the document retrieval function is usable ven when the magnification is varied. For example, when the user instructs document retrieval, the control signal, which is generated from the control panel 2009-1 at the time of 50% magnification variation, causes the scanner 2001-1 to execute an input operation with 100% magnification variation and causes the main-scan magnification varying section 2002-1 and sub-scan magnification varying section 2003-1 to execute an operation with 50% magnification variation. In other words, when the document retrieval is used, the magnification variation by the carriage (not shown) of the scanner 2001-1 is not executed, and the magnification varying operation is executed only by the signal processing.

Thereby, even at the time of magnification variation, the watermark detection section 2004-1 can execute watermark detection in main/sub-scan, and a high-precision document retrieval function can be provided.

Needless to say, like the second embodiment, the reverse function can be provided in Nin1.

Next, a third embodiment is described.

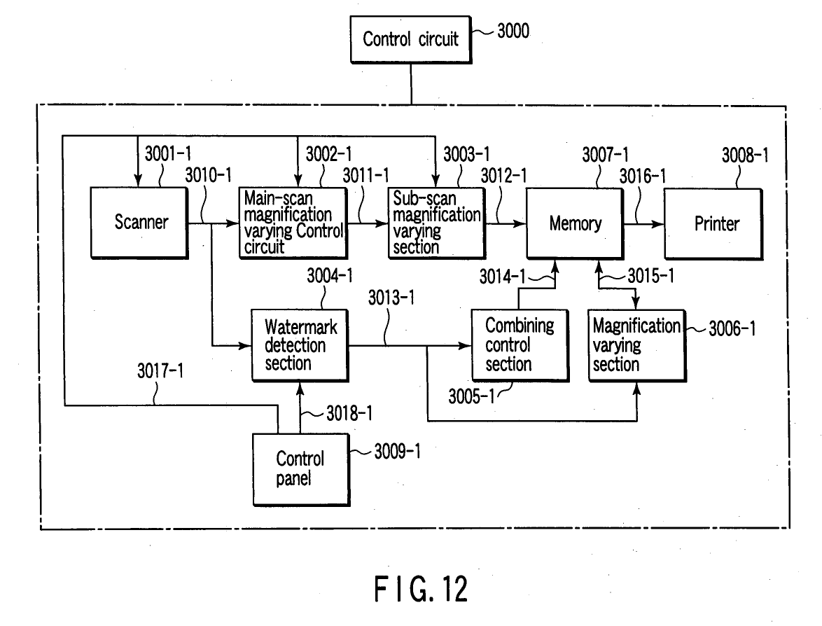

FIG. 12 schematically shows the structure of a digital multi-function peripheral (MFP) according to the third embodiment. Specifically, the digital MFP of the third embodiment comprises a control circuit 3000, a scanner 3001-1, a main-scan magnification varying section 3002-1, a sub-scan magnification varying section 3003-1, a watermark detection section 3004-1, a combining control section 3005-1, a magnification varying section 3006-1, a memory 3007-1, a printer 3008-1, and a control panel 3009-1.

The third embodiment is basically the same as the second embodiment, except that a hard disk drive is not provided, and the combining control section 3005-1 that instructs a combining control to the memory 3007-1 and the magnification varying section 3006-1 are added.

It is assumed that a page layout is included in watermark information in this embodiment.

FIG. 13 shows an example of the display operation on the control panel 3009-1 of the third embodiment. As shown in the Figure, when two modes, “2in1” and “AI2in1”, of the 2in1 are selected, control signals 3017-1 and 3018-1 are output from the control panel 3009-1 to execute the following control.

In the case of “2in1”, 71% driving is instructed to the carriage (not shown) of the scanner 3001-1, and the main-scan magnification variation is set at 71% and the sub-scan magnification variation is set at 100%. The instruction to the watermark detection 3004-1 relates to only the detection of presence/absence of copy prohibition.

In the case of “AI2in1”, 100% driving is instructed to the carriage (not shown) of the scanner 3001-1, and the main-scan magnification variation is set at 100% and the sub-scan magnification variation is set at 100%. The instruction to the watermark detection 3004-1 relates to only the extraction of layout information and the detection of copy prohibition.

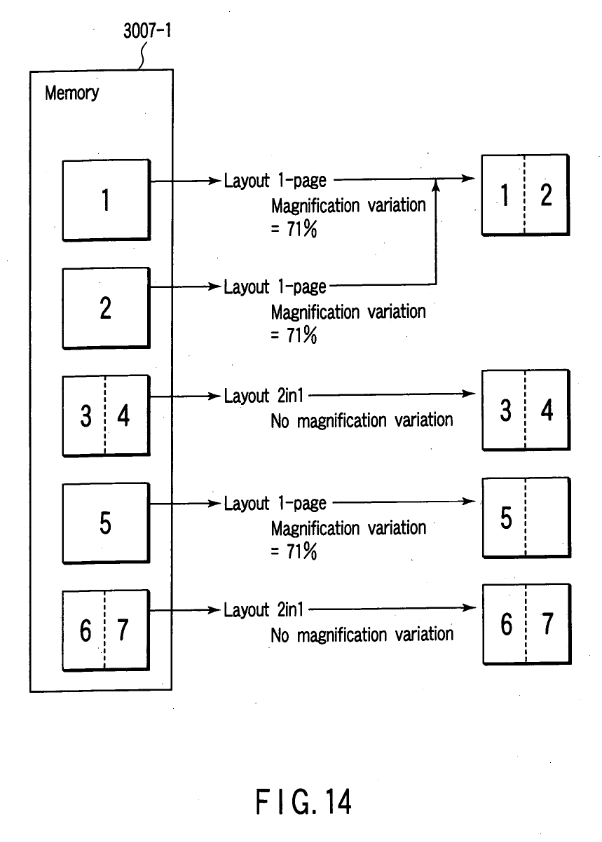

FIG. 14 shows an example of the operation of “AI2in1”.

Since all inputs to the memory 3007-1 are executed at 100%, the left-hand pictures (1, 2, 3, 4, 5, 6, 7) are originals. That is, the originals include 2in1 and single 1-page layouts.

As regards originals 1, 2 and 5, the watermark detection section 3004-1 determines that the layout is 1-page, on the basis of watermark information. The original 1 and original 2 are subjected to magnification variation at 71%. Then, in accordance with an instruction from the combining control section 3005-1, 2in1 image data, as shown in the right-hand part, is generated. As regards the original 5, the subsequent originals (6, 7) are determined not to be 1-page layout. Thus, a blank sheet is inserted, and 2in1 image data, as shown in the right-hand part, is generated. The original 3, 4 and the original 6, 7 are complete “2in1”. Thus, these are output as 2in1 image data as such.

If normal “2in1” is applied to the originals in this embodiment, the original 3, 4 and the original 6, 7 are excessively reduced, and the whole layout would obviously become out of order.

As has been described above, according to the third embodiment, the Nin1 process with high-level functions can be realized by the use of the layout detection result.

In the third embodiment, the watermark information is used for the layout detection. Needless to say, conventional layout analysis methods may alternatively be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
image input means for relatively moving an image on an original in a sub-scan direction, and reading the image;
magnification varying means for varying a magnification of image data that is read by the image input means;
magnification varying instruction means for issuing an instruction to the image input means and the magnification varying means in accordance with a desired magnification; and
watermark detection means for detecting watermark information from the image data that is read by the image input means.

2. The image processing apparatus according to claim 1, wherein the watermark detection means detects watermark information in accordance with the instruction from the magnification varying instruction means.

3. The image processing apparatus according to claim 1, further comprising layout analysis means for analyzing a layout from the image data that is read by the image input means, wherein the detection means detects watermark information using a layout analysis result from the layout analysis means.

4. The image processing apparatus according to claim 1, further comprising layout analysis means for analyzing a layout from the image data that is read by the image input means, wherein the layout analysis means analyzes the layout using the watermark information from the watermark detection means.

5. The image processing apparatus according to claim 1, further comprising storage means for storing the image data that is read by the image input means and magnification-varied image data from the magnification varying means, and read-out control means for controlling an order of read-out of the image data that is stored in the storage means, wherein the read-out control means controls a read-out operation in accordance with the watermark information that is detected by the detection means.

6. An image processing apparatus comprising:
image input means for relatively moving an image on an original in a sub-scan direction, and reading the image;
first magnification varying means for varying a magnification of image data, which is read by the image input means, in a main-scan direction;
second magnification varying means for varying a magnification of image data, which is read by the image input means, in the sub-scan direction;
magnification varying instruction means for issuing an instruction to the image input means, the first magnification varying means and the second magnification varying means in accordance with a desired magnification; and
watermark detection means for detecting watermark information from the image data that is read by the image input means.

7. The image processing apparatus according to claim 6, wherein the watermark detection means uses image data that is yet to be subjected to the magnification varying by the first and second magnification varying means.

8. The image processing apparatus according to claim 6, further comprising interpretation means for decoding a detection result from the watermark detection means, wherein the interpretation means executes interpretation in accordance with the instruction from the magnification varying instruction means.

9. An image processing apparatus comprising:
image input means for relatively moving an image on an original in a sub-scan direction, and reading the image;
magnification varying means for varying a magnification of image data, which is read by the image input means, in a main-scan direction and the sub-scan direction, and outputting magnification-varied image data;
magnification alteration instruction means for instructing magnification alteration to the image input means and the magnification varying means;
watermark detection means for detecting watermark information from the image data that is read by the image input means;
selection instruction means for instructing selection of a function that uses the watermark information detected by the watermark detection means; and
control means for executing a control to switch an instruction content of the magnification alteration instruction means in accordance with the selection instruction from the selection instruction means.

10. An image processing apparatus comprising:
image input means for relatively moving an image on an original in a sub-scan direction, and reading the image;
first reduction means for reducing image data, which is read by the image input means, in a main-scan direction and the sub-scan direction;
first instruction means for issuing an instruction to the image input means and the first reduction means;
watermark detection means for detecting watermark information from the image data that is read by the image input means;
storage means for storing image data that is reduced by the first reduction means;
read-out means for reading out image data that is stored in the storage means;
second reduction means for reducing image data that is read out by the read-out means;
combining means for combining a plurality of reduced image data;
second instruction means for issuing an instruction to the read-out means, the second reduction means and the combining means in accordance with a detection result of the watermark detection means; and
output means for outputting image data that is combined by the combining means.

11. An image processing apparatus comprising:
image input means for inputting image data on an original;
image processing means for processing image data that is input from the image input means;
process instruction means for instructing an image process to the image process means;
watermark detection means for detecting watermark information of a plurality of levels including an image management level, from the image data that is input from the image input means, regardless of an instruction content of the process instruction means; and
output means for outputting image data that is subjected to the image process in the image processing means.

12. An image processing apparatus comprising:
image input means for inputting image data on an original;
magnification varying means for varying a magnification of image data that is input from the image input means;
magnification ratio instruction means for instructing a magnification ratio to the magnification varying means;
watermark detection means for detecting watermark information including an image management level, from the image data that is input from the image input means, regardless of an instruction content of the magnification ratio instruction means; and
output means for outputting magnification-varied image data from the magnification varying means.

13. An image processing apparatus comprising:
image input means for inputting image data on an original;
magnification varying means for varying a magnification of image data that is input from the image input means;
magnification ratio instruction means for instructing a magnification ratio to the magnification varying means;
watermark detection means for detecting watermark information from the image data that is input from the image input means;
process means for executing a plurality of processes using a detection result from the watermark detection means; and
display means for displaying a process menu that is executed by the process means, in accordance with a magnification ratio that is instructed by the magnification ratio instruction means.

14. An image processing apparatus comprising:
image input means for inputting image data on an original;
page structure detection means for detecting whether image data, which is input from the image input means, comprises a single page or a plurality of pages;
reduction means for reducing the image data that is input from the image input means, using a page structure detection result from the page structure detection means;
image combining means for combining reduced image data of a plurality of pages of the image data, using the page structure detection result from the page structure detection means; and
output means for outputting image data that is combined by the image combining means.
